(19) United States
(12) Patent Application Publication
(10) Pub. No.: US 2002/0054439 A1
(43) Pub. Date: May 9, 2002

(54) Motor vehicle rearview mirror

(76) Inventors: Werner Seichter, Georgensgmuend (DE); Arno Schieweck, Schwaig (DE); Thomas Stolpe, Eckental (DE)

Correspondence Address: JACOBSON HOLMAN PLLC, 400 SEVENTH STREET N.W., SUITE 600, WASHINGTON, DC, 20004, US

(21) Appl. No.: 09/986,017

(22) Filed: Nov. 7, 2001

(30) Foreign Application Priority Data
Nov. 8, 2000 (DE) 100 55 320.6

(51) Int. Cl. G02B 5/08; G02B 7/182

(52) U.S. Cl. 359/877; 359/838; 359/872

(57) ABSTRACT

A motor vehicle rearview mirror that is installed in a vehicle power system of significantly more than 12 volts, whereby the number of parts and the production cost of the motor vehicle rearview mirror are not or only insignificantly increased. A consuming device is connected electrically in series to the electric motor, the consuming device affecting a decrease in the voltage at the electric motor and fulfilling a meaningful additional function.

### BACKGROUND OF THE INVENTION

The invention relates to a motor vehicle rearview mirror that has a mirror drive to adjust a mirror glass, wherein the drive includes at least one electric motor operatively connected to a step-down gear. An electrical feed line supplies the electric motor with electrical power in order to drive the step-down gear to adjust the mirror glass. One such rearview mirror including a foldable rearview mirror drive is disclosed in U.S. Pat. No. 6,022,113 which issued on Feb. 8, 2000. The specification and drawings of the patent are incorporated by reference herein as if reproduced in full.

In motor vehicles, especially passenger cars, power in the range of 12 to 14 volts is the customary operative power. Therefore, vehicle consuming devices are designed and configured in such a way that they can operate properly with this voltage. Because of continuously higher demands in vehicle comfort and safety, there are an increasing number of electrical consuming devices found in today's motor vehicles. This has led to a steady increase in current consumption. Likewise, the energy consumption by internal combustion engines has steadily declined due to engine optimization. Thus, the ratio of electrical energy consumption to the total energy consumption of the motor vehicle engine system is already relatively high.

To counteract this trend, it has been proposed that vehicle electrical power be significantly increased, thus resulting in a decrease in the ohmic losses in the vehicle electrical system. However, many consuming devices, such as electric motors for adjusting a vehicle mirror glass, cannot be used with the higher voltage, because the winding wires of the electric motors that are used are already so thin that, were the wire thickness to be decreased any further, reliable operation would no longer be possible. The use of electric motors with a higher rating or the use of a star connection, instead of a delta connection, is not feasible for economical reasons.

### BRIEF SUMMARY OF THE INVENTION

Therefore, an object of the invention is to provide a motor vehicle rearview mirror that can be installed in a vehicle power system of significantly more than 12 volts without changes being made in the dimensioning of the drive to adjust the mirror glass. In this way, the number of parts and the production cost of the motor vehicle rearview mirror are not or only insignificantly increased.

The invention solves the prior art problem in a vehicle power system of significantly more than 12 volts by having a consuming device connected in series between the feed line and the electric motor. The consuming device causes a decrease in the voltage provided to the electric motor and fulfills a meaningful additional function. By way of example, the consuming device fulfilling an additional function may be a mirror-heating element positioned behind the mirror glass. Another example is an electromagnet that may form part of the motor vehicle rearview mirror system. The consuming device affects a voltage drop, which reduces the increased vehicle voltage to an amount tolerated by the electric motors. To minimize the number of parts and the production cost, a consuming device is used that is either already present (a heating element) or fulfills a new desired additional function (an electromagnet). Further, because the drive motor is used for short periods of time, there is no conflict when using the consuming device in the invention as well as for its normal function.

Further developments of the invention are disclosed in the dependent claims. In the present invention, the consuming devices are designed in such a manner that the electric motors can also be driven at a vehicle voltage of 42 volts. This voltage will be used presumably in future motor vehicles.

Another especially economical solution is the use of an electromagnet, which may or may not already be present in the motor vehicle, as the consuming device and series resistor. In this case, additional parts will not be necessary.

### BRIEF DESCRIPTION OF THE DRAWING

An embodiment of the invention is explained in detail below with reference to the lone drawing in the form of a block diagram.

### DETAILED DESCRIPTION OF THE INVENTION

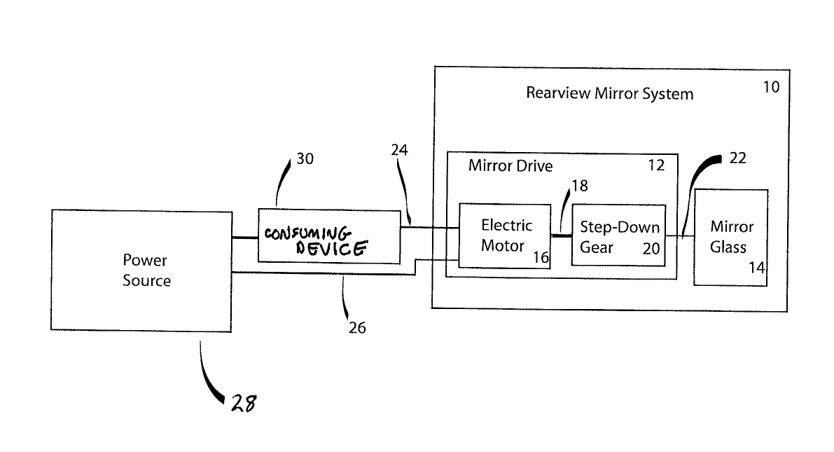

FIG. 1 is a schematic block diagram of a rearview mirror system 10 that includes a mirror drive 12 and a mirror glass 14. The mirror drive 12 includes an electric motor 16 having a rotating shaft 18 connected to a step-down gear 20. The step-down gear is operatively connected by coupling 22 to the mirror glass 14. In this way, operation of motor 16 acts to adjust and move mirror glass 14. The motor 16 operates by receiving power on two leads 24 and 26 from a power source 28. In the invention, power line 24 includes a consuming device 30 that acts as a series resistor. The consuming device is preferably an electromagnet but as mentioned before may be any other consuming device that can act as a resistor. An example of such a device is the heating element found behind the glass in a mirror system.

The present invention may be embodied in other forms without departing from the intent or essential characteristics. The described embodiment is considered in all respects as illustrative and not restrictive.

What is claimed is:

1. In a motor vehicle rearview mirror having a drive for mirror adjustment, wherein the drive includes at least one electric motor and a step-down gear and a feed line to supply the electric motor with electrical power, the improvement comprising a consuming device connected electrically in series to the electric motor, said consuming device both effecting a decrease in the voltage applied to the electric motor and performing a second meaningful function.

2. The motor vehicle rearview mirror, as claimed in claim 1, wherein the vehicle voltage is 42 volts.

3. The motor vehicle rearview mirror, as claimed in claim 1, wherein the consuming device is an electromagnet.

4. The motor vehicle rearview mirror, as claimed in claim 2, wherein the consuming device is an electromagnet.

5. The motor vehicle rearview mirror, as claimed in claim 1, wherein the drive is a folding drive and/or a mirror glass drive.

6. The motor vehicle rearview mirror, as claimed in claim 2, wherein the drive is a folding drive and/or a mirror glass drive.
